(19) United States
(12) Patent Application Publication
(10) Pub. No.: US 2017/0286617 A1
(43) Pub. Date: Oct. 5, 2017

(54) Holomedicine: Methodology, Process, Practice and Delivery

(71) Applicant: Michael DK. Zimmer, Scottsdale, AZ (US)

(72) Inventor: Michael DK. Zimmer, Scottsdale, AZ (US)

(21) Appl. No.: 15/089,577

(22) Filed: Apr. 3, 2016

(51) Int. Cl. G06F 19/00; H04N 7/15

(52) U.S. Cl. CPC G06F 19/3418; H04N 7/15

(57) ABSTRACT

Holomedicine is an innovated form that the discipline of medicine is rendered. Holomedicine allows for the practice and delivery of medicine through sensory camera technology transmits data to a Holomedicine display device that outputs data, figure(s), object(s) and human holoportation in the form of holographic imagery. Holographic imagery is broadcasted from a Holomedicine display device that creates illusions of data, figure(s), object(s) and human holoportation. Through the uses of Holomedicine providers and medical staff can perform healthcare from a remote location while interacting with patients in a freestanding simulated second and third dimension outlook. Holomedicine takes the practice and delivery of healthcare while blending augmented and virtual reality.

### FIELD AND BACKGROUND OF THE INVENTION

The present invention relates to the methodology, process, practice and delivery that the discipline of medicine is rendered. Specifically, the present invention relates to the medical usage of holographic imagery of data, figure(s), object(s) and human holoportation when practicing and delivering healthcare. Holomedicine allows for medicine to be practiced and delivered anywhere and anytime as providers, staff and patients have the ability to be separated while healthcare is rendered. In addition, holographic imagery is the foundation that healthcare is broadcasted from a Holomedicine display device to create illusions of data, figures, objects and human holoportation for a freestanding simulated second and third dimension outlook. Holomedicine provides an opportunity for data, figures, objects and human holoportation to provide remote monitoring, shared and controlled user interface feed, and store-and-forwarding transmission. Holomedicine reduces patient movement flow by limiting travel and communicable time.

### SUMMARY OF THE INVENTION

Regardless of the type of medicine that is practiced the methodology, process and delivered of Holomedicine remains the same. Sensory camera technology transmits data to a Holomedicine display device that outputs data, figure(s), object(s) and human holoportation in the form of holographic imagery. Holographic imagery allows for the practice and delivery of medicine through remote monitoring, shared and controlled user interface feed, and store-and-forwarding transmission.

Holomedicine is made possible through a Holomedicine Hub and the uses of wireless communication abilities for transmitting data, figure(s) object(s) and human holoportation. By allowing users to interact with a freestanding simulated, two and third dimensional perspective expands the body of knowledge when practicing and delivering medicine in a novel interactive model. Holomedicine connects providers, health professionals, staff and patients in a blended augmented and virtual reality that allows holographic data, figure(s), object(s) and human holoportation to be seen in an interactive nature.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the practice and delivery of the present invention involves performing or completing certain selected tasks or steps manually, automatically, or a combination thereof. Moreover, according to actual instrumentation and equipment of preferred embodiments of the practice and delivery of the present invention, several selected steps could be implemented by hardware or by software on any operating system of any firmware or a combination thereof.

### Advantages of the Invention

Holomedicine is a mix-blend of traditional performed care with the practice of telemedicine. Similar to traditional performed care, Holomedicine allows for a personal interactive physical argument feeling in a virtual state between patient and provider. Furthermore, Holomedicine is similar to telemedicine remote serving features as reduction in travel and commute time to practice and deliver care is possible.

Holomedicine solves patient travel, commute flow and patient to-be-seen wait time problems by transmitting holographic imagery of data, figure(s), object(s) and human holoportation to any location at any time. In addition, Holomedicine solves the problem of loss in physical provider and patient presents by providing care in an augmented, yet virtual state. The practice and delivery of Holomedicine is valuable toward patient and provider interactions. These interactions form meaningful sensations that cannot be replicated through the uses of telemedicine video conferencing. Holomedicine overcomes this fear as relationship between patient and provider are engaging that aids to the development of quality care.

Holomedicine too allows from touch and feel sensation when applications are used to assist with examinations, evaluations and treatments. The ability to touch and feel provides the provider with an advantage to accurately assess the needs of a patient. Holomedicine applications reduces the risk of unreliable transmission of information from patient to provider.

Holomedicine also helps to enhance communication between providers. For specific health needs, the opinion of colleagues and peers can occur using holographic imagery to discuss on medical cases in a two and three dimensional view to assess symptoms, treatment and overall condition of a patient. Holomedicine allows you to communicate to all members of your diagnostic team simultaneously, letting each level of doctor, from the specialist to the primary care provider, how a medical case is developing.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 Process flow of patient and provider using Holomedicine;

FIG. 2 Process flow of third-party uses of Holomedicine;

FIG. 3 Data flow diagram of patient and provider using Holomedicine;

FIG. 4 Data flow diagram of third-party uses of Holomedicine

### DETAILED DESCRIPTION OF THE INVENTION

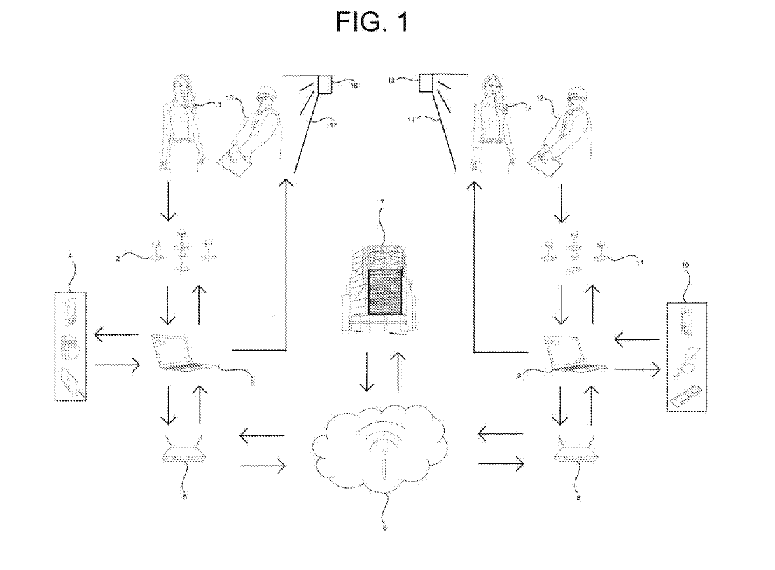

Referencing the Figures using numeric indicators FIG. 1 shows a process flow which Holomedicine is performed between a provider(s) 12 and patient(s) 1. Holomedicine operates from a Holomedicine Hub 7 that is a centralized location which transmits data, figure(s), object(s) and/or human holoportation. This transmission allows provider(s) 12 and patient(s) 1 to interact in a holographic form. Holomedicine can be initiated by a Holomedicine Hub 7, patient(s) 1 or provider(s) 12.

For example, when a patient 1 initiates Holomedicine he or she will surround their self with sensory camera(s) 2 that allows for the transmission of data, figures, objects and/or human holoportation. Data, figure(s), object(s) and/or human holoportation is then transmitted into a data operating system 3. The data operating system 3 then stores and forwards Holomedicine application/tool 4 and sensory camera 2 information through a router 5 linked to the internet 6. The internet 6 then transmits data, figure(s), object(s) and/or human holoportation onto a Holomedicine Hub 7 platform. The Holmedicine Hub 7 will then store and forward received data, figure(s), object(s) and/or human holoportation back into the internet 6, which the internet 6 forwards the original source of transmitted data, figure(s), object(s) and/or human holoportation to a receiving router 8. The receiving router 8 then transfers data, figure(s), object(s) and/or human holoportation into a receiving data operating system 9. Data, figure(s), object(s) and/or human holoportation is then transferred from the receiving data operating system 9 to a holomedicine display device 13 that holographically broadcasts 14 the transmitted data, figure(s), object(s) and/or human holoportation in a holographic form 15. The holographic form 15 communicates with the provider 12 which creates augmented and virtual dialog. In essence, this process is then reversed allowing for the provider 12 to transmit data, figure(s), object(s) and/or human holoportation to a patient 1. As the patient has Holomedicine applications/tools and sensory camera(s) the provider 12 too will have his or her own Holomedicine applications/tools 10 and sensory camera(s) 11.

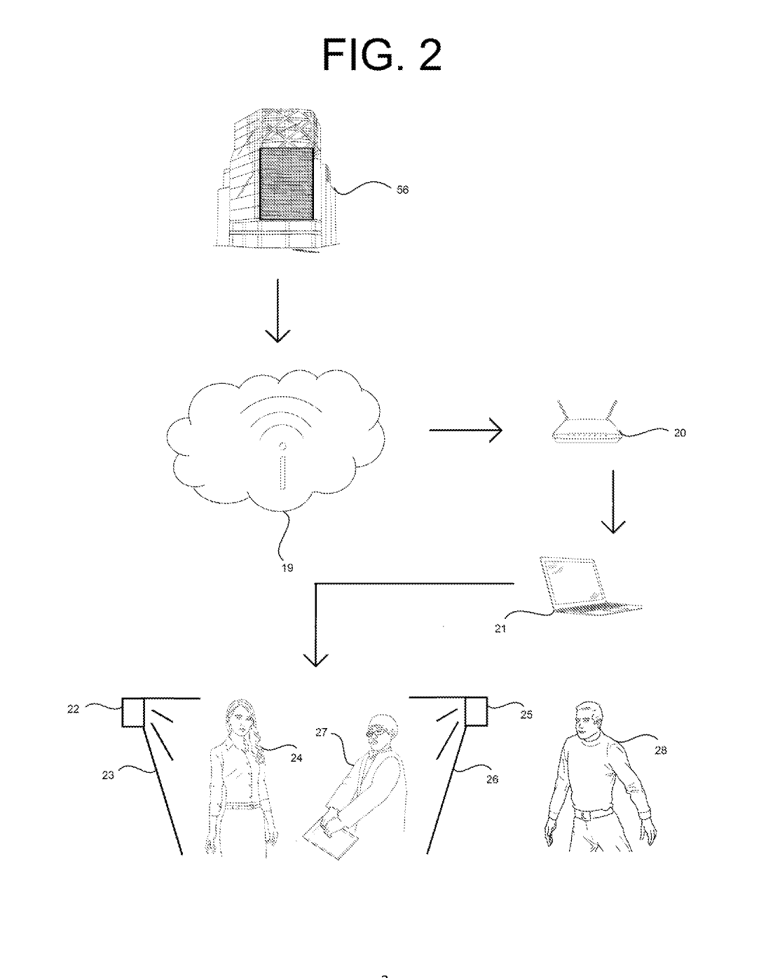

Referencing the Figures using numeric indicators FIG. 2 shows a process flow which Holomedicine is performed for third party 28 usage. Holomedicine operates from a Holomedicine Hub 56 platform that allows for a third party 28 to view holographic form(s) 24/27. Holomedicine can be initiated by a Holomedicine Hub 56 or third party 28. Once initiated the Holmedicine Hub 56 forwards data, figure(s), object(s) and/or human holoportation to the internet 19, which the internet 19 forwards data, figure(s), object(s) and/or human holoportation to a receiving router 20. The receiving router 20 then transfers data, figure(s), object(s) and/or human holoportation into a receiving data operating system 21. Data, figure(s), object(s) and/or human holoportation is then transferred from the receiving data operating system 21 to a Holomedicine display device(s) 22/25 that holographically broadcasts 23/28 the transmitted data, figure(s), object(s) and/or human holoportation in a holographic form(s) 24/27. This transmitted holographic form(s) 24/27 allows for third party 28 viewing.

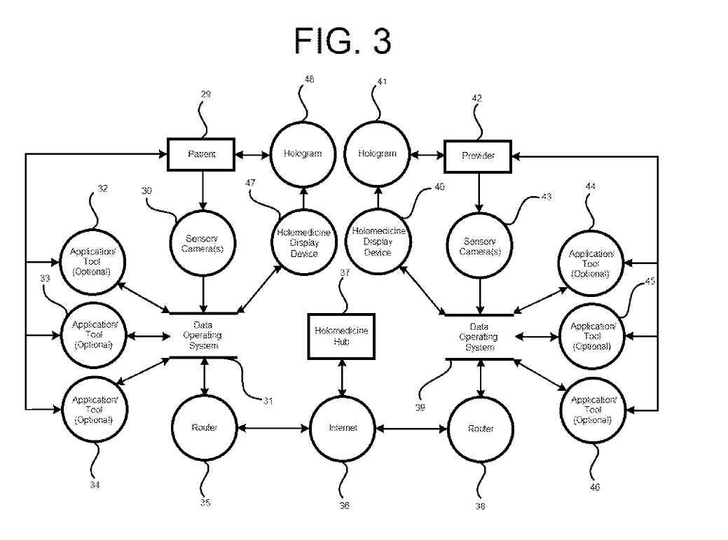

Referencing the Figures using numeric indicators FIG. 3 shows a data flow diagram which Holomedicine is performed between a provider(s) 42 and patient(s) 29. Holomedicine operates from a Holomedicine Hub 37 that is a centralized location which transmits data, figure(s), object(s) and/or human holoportation. This transmission allows provider(s) 42 and patient(s) 29 to interact in a holographic form. Holomedicine can be initiated by a Holomedicine Hub 37, patient(s) 29 or provider(s) 42.

For example, when a patient 29 initiates Holomedicine he or she will surround their self with sensory camera(s) 30 that allows for the transmission of data, figures, objects and/or human holoportation. Data, figure(s), object(s) and/or human holoportation is then transmitted into a data operating system 32. The data operating system 32 then stores and forwards Holomedicine application/tool 32/33/34 and sensory camera 30 information through a router 35 linked to the internet 36. The internet 36 then transmits data, figure(s), object(s) and/or human holoportation onto the Holomedicine Hub 37 platform. The Holmedicine Hub 37 will then store and forward received data, figure(s), object(s) and/or human holoportation back into the internet 36, which the internet 36 forwards the original source of transmitting Data, figure(s), object(s) and/or human holoportation to a receiving router 38. The receiving router 38 then transfers data, figure(s), object(s) and/or human holoportation into the receiving data operating system 39. Data, figure(s), object(s) and/or human holoportation is then transferred from the receiving data operating system 39 to a Holomedicine display device 40 that holographically broadcasts the transmitted data, figure(s), object(s) and/or human holoportation in a holographic form 41. The holographic form 41 communicates with the provider 42 which creates augmented and virtual dialog. In essence, this process is then reversed allowing for the provider 42 to transmit data, figure(s), object(s) and/or human holoportation to a patient 29. As the patient has Holomedicine applications/tools and sensory camera(s) the provider 42 too will have his or her own Holomedicine applications/tools 44/45/46 and sensory camera(s) 43.

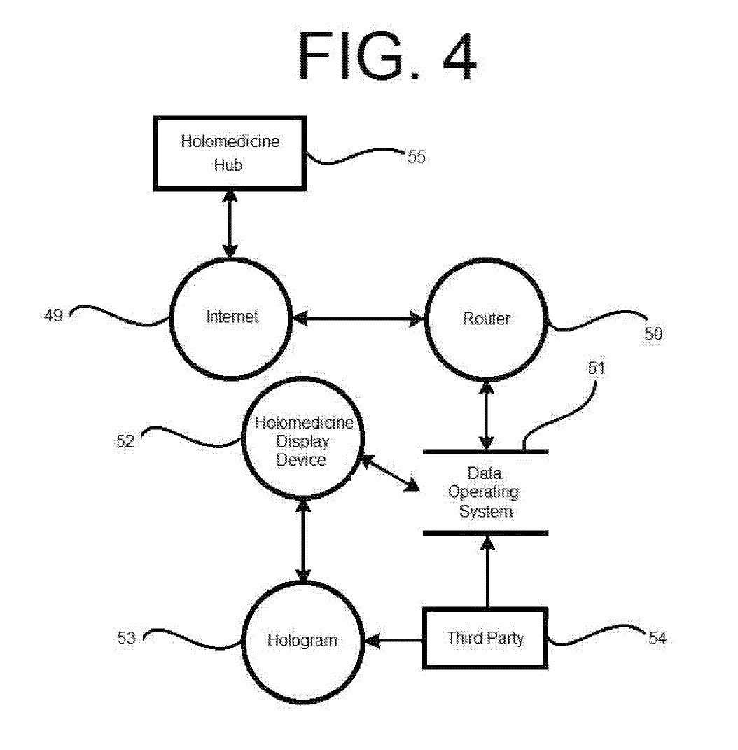

Referencing the Figures using numeric indicators FIG. 4 shows a data flow diagram which Holomedicine is performed for third party 54 usage. Holomedicine operates from a Holomedicine Hub 55 platform that allows for a third party 54 to view holographic form(s) 53. Holomedicine can be initiated by a Holomedicine Hub 56 or third party 28. Once initiated the Holmedicine Hub 55 forwards data, figure(s), object(s) and/or human holoportation to the internet 49, which the internet 49 forwards data, figure(s), object(s) and/or human holoportation to a receiving router 50. The receiving router 50 then transfers data, figure(s), object(s) and/or human holoportation into a receiving data operating system 51. Data, figure(s), object(s) and/or human holoportation is then transferred from the receiving data operating system 51 to a Holomedicine display device(s) 52 that holographically broadcasts the transmitted data, figure(s), object(s) and/or human holoportation in a holographic form(s) 53. This transmitted holographic form(s) 53 allows for third party 54 viewing.

### ELEMENT LIST

### Element Symbol Element Name

1 Patient
2 Sensory Camera(s)
3 Data Operating System
4 Holomedicine Applications/Tools
5 Router
6 Internet
7 Holomedicine Hub
8 Router
9 Data Operating System
10 Holomedicine Applications/Tools
11 Sensory Camera(s)
12 Provider
13 Holomedicine Display Device
14 Holographic Broadcast
15 Patient Hologram
16 Holomedicine Display Device
17 Holographic Broadcast
18 Provider Hologram
19 Internet
20 Router
21 Data Operating System
22 Holomedicine Display Device
23 Holographic Broadcast
24 Patient Hologram
25 Holomedicine Display Device
26 Holographic Broadcast
27 Provider Hologram
28 Third Party
29 Patient
30 Sensory Camera(s)
31 Data Operating System
32 Optional Holomedicine Application/Tool 1
33 Optional Holomedicine Application/Tool 2
34 Optional Holomedicine Application/Tool 3
35 Router
36 Internet
37 Holomedicine Hub
38 Router
39 Data Operating System
40 Holomedicine Display Device
41 Hologram
42 Provider
43 Sensory Camera(s)
44 Optional Holomedicine Application/Tool 1
45 Optional Holomedicine Application/Tool 2
46 Optional Holomedicine Application/Tool 3
47 Holomedicine Display Device
48 Hologram
49 Internet
50 Router
51 Data Operating System
52 Holomedicine Display Device
53 Hologram
54 Third Party
55 Holomedicine Hub
56 Holomedicine Hub

1. The term and understanding of Holomedicine.

2. The methodology, process, practice and delivery of Holomedicine.

3. Holomedicine Hub that is a centralize location which acts as a platform allowing for the transmission of data, figure(s), object(s) and human holoportation.

4. Holomedicine display device that broadcasts data, figure(s), object(s) and human holoportation.

5. Holomedicine applications and tools used to assisted with the interaction and sharing of medical information.

6. Provider interaction with a patient, data, figure(s) and/or object(s) in a holographic form.

7. Patient interaction with a provider, data, figure(s) and/or object(s) in a holographic form.

8. Third party interaction with a provider, patient data, figure(s) and/or object(s) in a holographic form.
